(19) United States
(12) Patent Application Publication
(10) Pub. No.: US 2026/0299834 A1
(43) Pub. Date: Oct. 1, 2026

(54) MEMORY MANAGEMENT METHOD AND MEMORY CONTROLLER

(71) Applicant: Hefei Kaimeng Technology Co., Ltd., Anhui (CN)

(72) Inventors: Zhi WANG, Anhui (CN); Yu ZHANG, Anhui (CN); Dongsheng GUAN, Anhui (CN); Wei WANG, Anhui (CN); PengPeng QIN, Anhui (CN)

(73) Assignee: Hefei Kaimeng Technology Co., Ltd., Anhui (CN)

(21) Appl. No.: 19/660,181

(22) Filed: Apr. 27, 2026

(30) Foreign Application Priority Data
May 29, 2025 (CN) 202510710787.9

(51) Int. Cl. G06F 3/06

(52) U.S. Cl. CPC G06F 3/0659; G06F 3/0604; G06F 3/0679

(57) ABSTRACT

The present disclosure provides a memory management method and a memory controller, applied to a storage device configured with a memory module. The method includes: obtaining one or more big data read commands and one or more small data read commands of the same command priority; determining whether to enter a small data priority mode based on the receipt order and quantity of the one or more small data read commands; and after entering the small data priority mode, if a big data read command is currently being executed, suspending the execution of the big data read command and starting to execute the one or more small data read commands. The present disclosure achieves preemptive scheduling of small data read commands over big data read commands under equal priority, improving the response speed of small data read commands and enhancing user experience in interactive scenarios.

### CROSS-REFERENCE TO RELATED APPLICATION

This application claims the priority benefit of China application serial no. 202510710787.9, filed on May 29, 20225. The entirety of the above-mentioned patent application is hereby incorporated by reference herein and made a part of this specification.

### BACKGROUND

### Technical Field

The present disclosure relates to the field of storage technology, and more particularly to a memory management method and a memory controller for optimizing the execution of read tasks in Universal Flash Storage (UFS) devices under mixed-load conditions.

### Description of Related Art

With the rapid growth in storage performance demands from mobile devices and embedded systems, Universal Flash Storage (UFS) has become the standard storage medium for smartphones, tablet computers, and Internet-of-Things devices, owing to its high bandwidth, low latency, and low power consumption characteristics.

In real-time interactive scenarios on mobile devices, the read response speed of highly interactive requests directly determines the smoothness and perceived experience of user operations. For example, when a user scrolls through a message list, the text, thumbnails, or emoji of each chat message need to be loaded quickly; real-time rendering of skill icons and map elements in games relies on instant data reading; real-time feedback for photo previews or AR filters requires millisecond-level responses. If the read latency of highly interactive requests is high, users will directly perceive interface lag and operational disconnection, and may even mistakenly believe the device is underperforming.

However, UFS devices often receive a series of read tasks (Read Tasks) of the same command priority. The conventional scheduling approach processes requests strictly in the order in which the tasks are issued, resulting in excessively long response times for small-block data and poor user experience. For example, when a large data block (such as video data) occupies the bandwidth, the loading of message lists may be delayed, requiring users to wait several seconds before seeing the latest messages, severely disrupting the immersive experience of instant communication.

### SUMMARY

In view of this, the present disclosure provides a memory management method and a memory controller, applied to a storage device configured with a memory module, which effectively improves the response speed of small data read commands and enhances user interactive experience by suspending the execution of big data read commands and prioritizing small data read commands of the same command priority.

One or more embodiments of the present disclosure provide a memory management method, applied to a storage device configured with a memory module. The method includes: obtaining one or more big data read commands and one or more small data read commands of the same command priority; determining whether to enter a small data priority mode based on the acquisition order and number of the one or more small data read commands; and after entering the small data priority mode, if a big data read command is currently being executed, suspending the execution of the big data read command and starting to execute the one or more small data read commands.

In one or more embodiments of the present disclosure, after entering the small data priority mode, the method further includes: obtaining a yield data amount based on the total data amount corresponding to the big data read command; each time a small data read command is completed, subtracting the data amount corresponding to the small data read command from the yield data amount to update the yield data amount; and when the updated yield data amount is not a positive value, resuming and executing the big data read command.

In one or more embodiments of the present disclosure, the yield data amount is calculated according to the following formula: n=L/k, wherein n is the yield data amount, L is the total data length corresponding to the big data read command, and k is the adjustable parameter, wherein the total data length corresponding to the big data read command is greater than the data threshold, and the data amount corresponding to each small data read command is no greater than the data threshold.

In one or more embodiments of the present disclosure, the method further includes: adjusting the value of k correspondingly based on the current access load state of the storage device; wherein the higher the access load state, the greater the value of k.

In one or more embodiments of the present disclosure, the method further includes: after completing the execution of the big data read command, continuing to execute one or more remaining small data read commands that have not yet been executed in the small data priority mode; and if the yield data amount is a positive value and all of the one or more small data read commands have been completed, resuming and executing the big data read command.

In one or more embodiments of the present disclosure, the method further includes: after completing the execution of the big data read command, recalculating a new yield data amount corresponding to a next big data read command based on the next big data read command; and if the next big data read command is suspended, updating the new yield data amount based on the data amount of each small data read command executed in the small data priority mode.

In one or more embodiments of the present disclosure, determining whether to enter the small data priority mode based on the acquisition order and the number of the one or more small data read commands includes: detecting whether there are no fewer than N small data read commands among the most recently acquired M read commands, wherein M is greater than N, and both are positive integers; and if no fewer than N small data read commands are detected, entering the small data priority mode.

In one or more embodiments of the present disclosure, while in the small data priority mode, the method further includes: detecting whether there are any small data read commands among the most recently consecutively acquired X read commands; if no small data read commands are present among the most recently consecutively acquired X read commands, exiting the small data priority mode; wherein X is a positive integer, and the value of X is dynamically adjusted based on the current access load state of the storage device, wherein the higher the access load state, the greater the value of X.

In one or more embodiments of the present disclosure, after entering the small data priority mode, if a big data read command is currently being executed, suspending the execution of the big data read command and starting to execute the one or more small data read commands includes: establishing a super-priority queue (SRQ) for recording the one or more small data read commands, wherein the big data read commands are recorded in a high-priority queue (HRQ) or a regular priority queue (RQ), and the super-priority queue (SRQ) is processed with higher priority than the high-priority queue (HRQ) or the regular priority queue (RQ); suspending the currently executing big data read command and saving the context state of the execution process of the big data read command; processing the one or more small data read commands in the super-priority queue (SRQ) in First In First Out (FIFO) order; and when resuming the execution of the big data read command, continuing to execute the big data read command based on the context state.

In one or more embodiments of the present disclosure, the method further includes: dividing the cache resources of the memory module into a static read buffer and a dynamic read buffer; dedicating the dynamic read buffer to storing data corresponding to the super-priority queue (SRQ); allocating the static read buffer to data corresponding to the high-priority queue (HRQ) or the regular priority queue (RQ); and in the small data priority mode, when the storage space of the dynamic read buffer is insufficient, allowing small data read commands in the super-priority queue (SRQ) to request storage space from the static read buffer, and prohibiting the storage space of the dynamic read buffer from being allocated to commands other than those in the super-priority queue (SRQ).

One or more embodiments of the present disclosure provide a memory controller for controlling a storage device configured with a memory module. The memory controller includes: a memory interface control circuit electrically connected to the memory module; and a processor electrically connected to the memory interface control circuit, wherein the processor is further electrically connected to a connection interface circuit of the storage device, so as to be electrically connected to a host system. The processor is configured to: obtain one or more big data read commands and one or more small data read commands of the same command priority; determine whether to enter a small data priority mode based on the acquisition order and number of the one or more small data read commands; and after entering the small data priority mode, if a big data read command is currently being executed, suspend the execution of the big data read command and start to execute the one or more small data read commands.

Based on the above, the memory management method and memory controller provided by the present disclosure can achieve preemptive scheduling of small data read commands over big data read commands under equal priority. By determining the acquisition frequency and number of small data read commands, the system dynamically decides whether to enter the small data priority mode, enabling the system to intelligently adapt to different workload environments. In the small data priority mode, the method suspends the currently executing big data read command and prioritizes the execution of small data read commands.

### BRIEF DESCRIPTION OF THE DRAWINGS

FIG. 1 is a block diagram illustrating a host system and a storage device according to an embodiment of the present disclosure.

FIG. 2 is a flowchart illustrating a memory management method according to an embodiment of the present disclosure.

FIG. 3 is a timing diagram illustrating the execution timing of read commands under a conventional scheduling method according to an embodiment of the present disclosure.

FIG. 4 is a timing diagram illustrating the storage device receiving a plurality of small data read commands while executing a big data read command, according to an embodiment of the present disclosure.

FIG. 5 is a schematic diagram illustrating the scheduling of the storage device after entering the small data priority mode, according to an embodiment of the present disclosure.

FIG. 6 is a timing diagram illustrating the storage device resuming execution of a big data read command after completing the execution of small data read commands, according to an embodiment of the present disclosure.

FIG. 7 is a detailed timing diagram illustrating the interaction among the memory controller, the regular priority queue (RQ)/high-priority queue (HRQ), and the super-priority queue (SRQ), according to an embodiment of the present disclosure.

### DESCRIPTION OF THE EMBODIMENTS

Reference will now be made in detail to the exemplary embodiments of the present disclosure, examples of which are illustrated in the accompanying drawings. Wherever possible, the same reference symbols are used in the drawings and the description to refer to the same or similar parts.

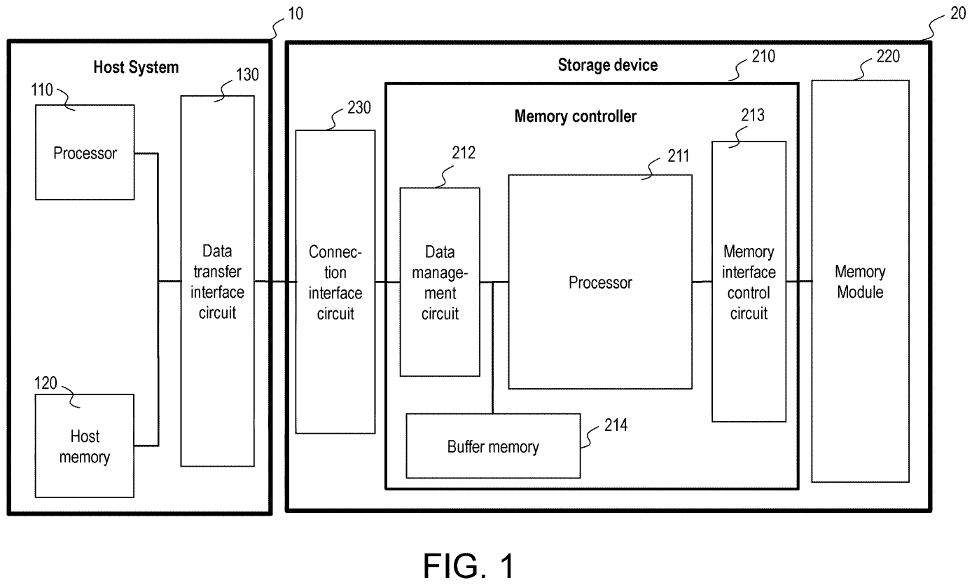

FIG. 1 is a block diagram of a host system and a storage device according to an embodiment of the present disclosure. Referring to FIG. 1, the host system 10 is, for example, a personal computer, a laptop computer, or a server. The host system (Host System) 10 includes a processor (Processor) 110 (also referred to as a second processor), a host memory (Host Memory) 120 (also referred to as main memory), and a data transfer interface circuit (Data Transfer Interface Circuit) 130. In this embodiment, the processor 110 is coupled to (also referred to as electrically connected to) the host memory 120 and the data transfer interface circuit 130. In another embodiment, the processor 110, the host memory 120, and the data transfer interface circuit 130 are electrically connected to each other via a system bus (System Bus). In this embodiment, the processor 110, the host memory 120, and the data transfer interface circuit 130 may be disposed on a motherboard of the host system 10.

The storage device 20 includes a memory controller (Memory Controller) 210, a memory module (Memory Module) 220 (also referred to as a rewritable non-volatile memory module (Rewritable Non-Volatile Memory Module)), and a connection interface circuit (Connection Interface Circuit) 230. The memory controller 210 includes a processor 211 (also referred to as a first processor), a data management circuit (Data Management Circuit) 212, a memory interface control circuit (Memory Interface Control Circuit) 213, and a buffer memory 214.

In this embodiment, the memory module 220 may be a Universal Flash Storage (UFS) module. UFS is a high-performance flash storage specification designed for mobile devices and consumer electronics, featuring high bandwidth, low latency, and low power consumption. UFS memory employs MIPI (Mobile Industry Processor Interface) M-PHY and UniPro (Unified Protocol) protocols, supporting full-duplex communication and command queuing technology, enabling simultaneous processing of multiple read and write requests, so as to significantly improve data transfer efficiency.

The memory management method of the present disclosure is particularly suitable for optimizing read task scheduling of UFS devices under mixed-load scenarios. By implementing preemptive scheduling of big data read commands by small data read commands, the performance advantages of UFS devices can be fully utilized, further enhancing the system's responsiveness to real-time interactive scenarios.

In this embodiment, the host system 10 is electrically connected to the storage device 20 via the data transfer interface circuit 130 and the connection interface circuit 230 of the storage device 20 to perform data access operations. For example, the host system 10 may store data into the storage device 20 or read data from the storage device 20 via the data transfer interface circuit 130.

In this embodiment, the number of data transfer interface circuits 130 may be one or more. Via the data transfer interface circuit 130, the motherboard may be electrically connected to the storage device 20 in a wired or wireless manner. The storage device 20 may be, for example, a USB flash drive, a memory card, a Solid State Drive (SSD), or a wireless memory storage device. The wireless memory storage device may be, for example, a Near Field Communication (NFC) memory storage device, a WiFi memory storage device, a Bluetooth memory storage device, or a low-power Bluetooth memory storage device (e.g., iBeacon), among other memory storage devices based on various wireless communication technologies. In addition, the motherboard may also be electrically connected to a Global Positioning System (GPS) module, a network interface card, a wireless transmission device, a keyboard, a display, speakers, and various other I/O devices via a system bus.

In this embodiment, the data transfer interface circuit 130 and the connection interface circuit 230 are interface circuits compatible with the Peripheral Component Interconnect Express (PCI Express) standard. Furthermore, data transfer between the data transfer interface circuit 130 and the connection interface circuit 230 is performed using the Non-Volatile Memory express (NVMe) communication protocol.

Furthermore, in another embodiment, the connection interface circuit 230 may be packaged together with the memory controller 210 in a single chip, or the connection interface circuit 230 may be disposed outside a chip that includes the memory controller 210.

In this embodiment, the host memory 120 is used to temporarily store instructions or data executed by the processor 110. In this embodiment, the host memory 120 may be a Dynamic Random Access Memory (DRAM), a Static Random Access Memory (SRAM), or the like. However, it should be understood that the present disclosure is not limited thereto, and the host memory 120 may also be other suitable memory.

The memory controller 210 is configured to execute a plurality of logic gates or control instructions implemented in hardware form or firmware form, and to perform write, read, and erase operations on the memory module 220 according to instructions from the host system 10.

More specifically, the processor 211 in the memory controller 210 is hardware with computing capability, used to control the overall operation of the memory controller 210. Specifically, the processor 211 is programmed with a plurality of control instructions/program codes, and when the storage device 20 is in operation, these control instructions/program codes are executed to perform write, read, and erase operations on data. In addition, the processor 211 is configured to execute the memory management method provided by the present disclosure.

In other embodiments, the control instructions/program codes corresponding to the data read method may further be implemented as circuit units in hardware form to implement the memory management method provided by the present disclosure.

It is worth noting that in this embodiment, the processor 110 and the processor 211 are, for example, a Central Processing Unit (CPU), a micro-processor, or other programmable processing units (Microprocessor), a Digital Signal Processor (DSP), a programmable controller, an Application Specific Integrated Circuit (ASIC), a Programmable Logic Device (PLD), or other similar circuit components. The present disclosure is not limited thereto.

In this embodiment, as described above, the memory controller 210 further includes the data management circuit 212 and the memory interface control circuit 213. It should be noted that operations performed by the individual components of the memory controller 210 may also be regarded as operations performed by the memory controller 210.

The data management circuit 212 is electrically connected to the processor 211, the memory interface control circuit 213, and the connection interface circuit 230. The data management circuit 212 is configured to receive instructions from the processor 211 to perform data transmission. For example, the data management circuit 212 reads data from the host system 10 (e.g., the host memory 120) via the connection interface circuit 230 and writes the read data to the memory module 220 via the memory interface control circuit 213 (e.g., performing corresponding write operations according to various write commands from the host system 10). For another example, the data management circuit 212 performs read operations according to read commands from the host system 10, reads data from one or more physical units of the memory module 220 via the memory interface control circuit 213 (the data may be read from one or more memory cells in one or more physical units), and writes the read data to the host system 10 (e.g., the host memory 120) via the connection interface circuit 230. In another embodiment, the data management circuit 212 may also be integrated into the processor 211.

The memory interface control circuit 213 is configured to receive instructions from the processor 211 and cooperate with the data management circuit 212 to perform write (also referred to as programming) operations, read operations, or erase operations on the memory module 220.

In addition, data to be written to the memory module 220 is converted into a format acceptable to the memory module 220 via the memory interface control circuit 213. Specifically, when the processor 211 needs to access the memory module 220, the processor 211 transmits a corresponding command sequence to the memory interface control circuit 213 to instruct the memory interface control circuit 213 to execute a corresponding operation. For example, the command sequences may include a write command sequence for instructing writing of data, a read command sequence for instructing reading of data, an erase command sequence for instructing erasing of data, and corresponding command sequences for instructing various memory operations. The command sequences may include one or more signals, or data on a bus. The signals or data may include command codes or program codes. For example, a read command sequence may include information such as a read identifier, a memory address, a physical address, and the like.

In addition, the memory controller 210 establishes a Logical-to-Physical address mapping table and a Physical-to-Logical address mapping table to record the mapping relationship between logical addresses of logical units (e.g., logical blocks, logical pages) allocated to the memory module 220 and physical addresses of physical units (e.g., physical erase units/physical blocks, physical pages). In other words, the memory controller 210 may look up the physical unit mapped by a logical unit through the Logical-to-Physical address mapping table (also referred to as the logical-to-physical mapping table) (e.g., look up the physical page mapped by a logical page; look up the physical address mapped by a logical address), and the memory controller 210 may look up the logical unit mapped by a physical unit through the Physical-to-Logical address mapping table (also referred to as the physical-to-logical mapping table) (e.g., look up the logical page mapped by a physical page; look up the logical address mapped by a physical address).

The buffer memory 214 is electrically connected to the processor 211 and is configured to temporarily store data and commands from the host system 10, data from the memory module 220, and various system data for managing the storage device 20.

In the present embodiment, the buffer memory 214 is configured to provide the required cache resources when the processor 211 executes the memory management method of the present disclosure. Specifically, when the processor 211 determines to enter the small data priority mode based on the acquisition order and quantity of small data read commands, the storage space of the buffer memory 214 may be dynamically divided into a static read buffer and a dynamic read buffer. The dynamic read buffer is dedicated to storing data corresponding to small data read commands in the super-priority queue (SRQ), while the static read buffer is allocated to data corresponding to read commands in the high-priority queue (HRQ) or the regular priority queue (RQ). In certain circumstances, the dynamic read buffer may also request storage space from the static read buffer. This dynamic allocation mechanism of cache resources ensures that, in the small data priority mode, small data read commands always have sufficient cache space available, so as to guarantee the smooth execution of small data read commands even when execution of big data read commands is suspended.

The processor 211 is configured to manage a plurality of read command queues based on the type of read commands and the system operating state. After the processor 211 determines to enter the small data priority mode, a super-priority queue (SRQ), a high-priority queue (HRQ), and a regular priority queue (RQ) are established to store different types of read commands respectively. The processor 211 allocates commands to the corresponding queues based on the size of the data to be read and processes the commands in accordance with queue priority order. Among them, small data read commands in the super-priority queue (SRQ) are executed with higher priority than commands in other queues, even when those commands have the same command priority.

The memory module 220 is electrically connected to the memory controller 210 (specifically, electrically connected to the memory interface control circuit 213) and is configured to store user data transmitted by the host system 10.

Specifically, the memory module 220 includes a plurality of chips, each chip is further subdivided into a plurality of planes, and each plane includes a plurality of physical blocks. In addition, each physical block in the memory module 220 further includes a plurality of physical pages, and each physical page includes a plurality of memory cells. It should be noted that the present disclosure is not limited to the size of each physical page and logical page.

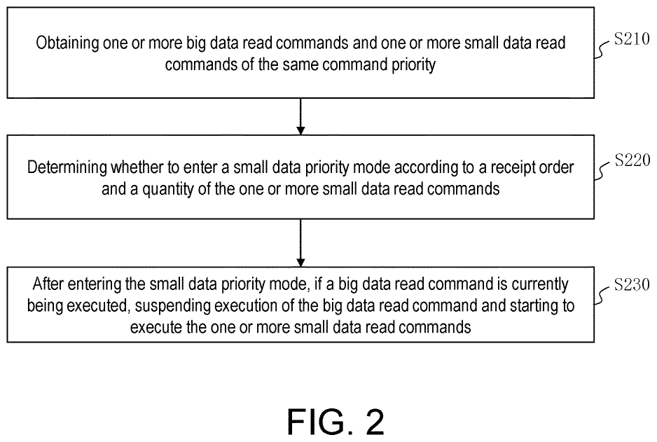

FIG. 2 is a flowchart of a memory management method according to an embodiment of the present disclosure.

Referring to FIG. 2, in step S210, one or more big data read commands and one or more small data read commands having the same command priority are obtained. Specifically, during normal operation of the storage device 20, the processor 211 receives and executes various read commands from the host system 10. These read commands may have different priorities; for example, read commands for foreground tasks have high priority, and read commands for background tasks have low priority. For read commands of equal priority, conventional approaches typically process them in receipt order(e.g., acquisition order). However, in the present embodiment, the processor 211 identifies the type of received commands, recognizing read commands with a data amount greater than a preset threshold (e.g., 8 kilobytes) as big data read commands, and recognizing read commands with a data amount not greater than the preset threshold as small data read commands. Notably, in the present embodiment, the host system 10 may attach interactivity information when transmitting read commands to indicate the interactive importance of the read commands. Based on this information, the processor 211 may further classify read commands into commands corresponding to the regular priority queue (RQ) (with a general command priority) and commands corresponding to the high-priority queue (HRQ) (with a high command priority). This classification mechanism enables the storage device 20 to more accurately identify and handle read requests that have a greater impact on the user's interactive experience.

In step S220, the processor 211 determines whether to enter the small data priority mode based on the receipt order and quantity of the one or more small data read commands.

Specifically, the processor 211 employs a sliding window counting mechanism to detect whether at least N small data read commands exist among the most recently obtained M read commands, wherein M is greater than N; for example, detecting 3 or more small data read commands among the most recently received 10 read commands. If this condition is satisfied, the processor 211 determines that the current system is in a highly interactive real-time scenario (also referred to as a strong interactive state/strong interactive scenario) and needs to enter the small data priority mode to improve the response speed of small data read commands. In addition, the processor 211 may also dynamically adjust the parameters of the determination condition based on the current access load state of the storage device; for example, raising the threshold for entering the small data priority mode under a high load state to avoid over-allocating system resources to small data read tasks. It should be noted that the present disclosure is not limited to specific numerical settings of M and N.

In step S230, after entering the small data priority mode, if a big data read command is currently being executed, the processor 211 suspends execution of the big data read command and begins to execute the one or more small data read commands.

Specifically, the processor 211 first establishes a dedicated super-priority queue (SRQ) for recording the one or more small data read commands. At the same time, the processor 211 ensures that the big data read command is appropriately recorded in the high-priority queue (HRQ) or the regular priority queue (RQ) for subsequent processing. The processor 211 configures the system such that the super-priority queue (SRQ) has a higher processing priority than the high-priority queue (HRQ) or the regular priority queue (RQ), so as to ensure that small data read commands are processed with priority.

When the processor 211 needs to execute small data read commands in the super-priority queue (SRQ), if the processor 211 currently has a big data read command being executed, the processor 211 suspends the big data read command currently being executed and saves the complete context state information of the execution process of the big data read command. The context state information includes, but is not limited to, key parameters such as the current execution progress, register state, and memory pointer position, so as to ensure that execution of the big data read command can subsequently be accurately resumed.

The processor 211 then processes the one or more small data read commands in the super-priority queue (SRQ) one by one in First In First Out (FIFO) order, ensuring that these small data read commands can be responded to in a timely manner. When it is necessary to resume execution of the previously suspended big data read command, the processor 211 continues to execute the big data read command from the point of suspension based on the previously saved context state information, ensuring the integrity and accuracy of data reading.

In order to efficiently manage storage resources, the processor 211 instructs the storage device 20 to divide the cache resources of the memory module 220 into two parts: a static read buffer and a dynamic read buffer. The processor 211 dedicates the dynamic read buffer to storing data corresponding to small data read commands in the super-priority queue (SRQ), ensuring that small data read commands always have dedicated cache space available. Meanwhile, the processor 211 allocates the static read buffer to data corresponding to the high-priority queue (HRQ) or the regular priority queue (RQ), for supporting the execution of big data read commands.

During the operation of the small data priority mode, the processor 211 continuously monitors the usage of the dynamic read buffer. When the storage space of the dynamic read buffer is insufficient to meet the demands of small data read commands in the super-priority queue (SRQ), the processor 211 allows these small data read commands to request additional storage space from the static read buffer, ensuring that the execution of small data read commands is not delayed due to insufficient cache space. Meanwhile, in order to maintain the rationality of resource allocation, the processor 211 prohibits the storage space of the dynamic read buffer from being allocated to commands other than those in the super-priority queue (SRQ), ensuring that the dedicated resources of small data read commands are not occupied by other commands.

In order to prevent big data read commands from being indefinitely deferred in execution, which would lead to resource starvation, the processor 211 implements a precise resource yield mechanism. After entering the small data priority mode, the processor 211 first calculates an initial yield data amount based on the total data amount of the big data read command currently being executed. The yield data amount represents the upper limit of the data amount that the big data read command is willing to yield in terms of execution rights, and is a key parameter for ensuring system fairness and efficiency.

The yield data amount is calculated using the formula n=L/k, wherein n is the yield data amount, L is the total data length corresponding to the big data read command, and k is an adjustable parameter. In the present embodiment, the processor 211 ensures that the total data length corresponding to the big data read command is greater than 8 kilobytes (which is the threshold for identifying a big data read command), and that the data amount corresponding to each small data read command is not greater than the data threshold (e.g., 8 kilobytes, which is the threshold for identifying a small data read command). It should be noted that the present disclosure is not limited to any specific value of the data threshold.

Each time the processor 211 completes execution of a small data read command, the processor 211 subtracts the actual data amount corresponding to the small data read command from the yield data amount, so as to dynamically update the current value of the yield data amount. This precise resource calculation method ensures that the system has a clear upper limit on the prioritized processing of small data read commands, avoiding the problem of big data read commands being indefinitely deferred.

When the processor 211 detects that the updated yield data amount is not a positive value, this indicates that the big data read command has yielded sufficient execution resources, and the processor 211 immediately stops accepting preemption by new small data read commands and resumes execution of the previously suspended big data read command, ensuring that the big data read task can ultimately be completed.

In order to adapt to different system operating environments, the processor 211 dynamically adjusts the value of k in the formula based on the current access load state of the storage device 20. When the system is under a high access load state, the processor 211 increases the value of k to reduce the yield data amount, thereby reducing the preemption frequency of small data read commands and ensuring that system resources are used more for processing the main workload. Conversely, when the system is under a low access load state, the processor 211 decreases the value of k to increase the yield data amount, allowing more small data read commands to receive priority processing and improving the system's responsiveness to interactive requests. This dynamic adjustment mechanism enables the system to flexibly balance response speed and processing efficiency based on actual operating conditions.

It is worth noting that the present disclosure adopts a yield mechanism based on data amount rather than the number of completions of small data read commands, and this design consideration has specific technical significance. If the number of completions were used as the unit of measurement for the yield mechanism, the system would be unable to accurately reflect the differences in resource consumption among different read commands. Specifically, when the system processes multiple small data read commands with significantly different data amounts, measuring solely by number of completions would result in imbalanced resource allocation: a small data read command with a data amount of 100 bytes and a small data read command with a data amount close to the threshold (e.g., 7 kilobytes) would be treated as equivalent, both consuming the same yield quota (number of completions). This coarse-grained measurement method does not conform to the principle of fair resource allocation, and may cause the system to exhaust the yield quota after processing a small number of small data read commands whose data amounts are close to the threshold, or to excessively delay the execution of big data read commands when processing multiple read commands with very small data amounts. In contrast, the yield mechanism based on actual data amount can precisely reflect the resource consumption of each read command, ensuring the precision and fairness of system resource allocation, while effectively preventing big data read commands from encountering resource starvation under the premise of maintaining the response advantage in highly interactive scenarios. This data-amount-based resource management strategy can better adapt to various complex workload scenarios and better achieve a balance in system resource utilization.

In an embodiment, the processor 211 also continuously monitors the status of read commands. When no small data read command exists among X consecutively received read commands, the processor 211 determines that the current system is no longer in a highly interactive real-time scenario and exits the small data priority mode, restoring the normal command processing order. X is a positive integer, and the value of X is dynamically adjusted based on the system load state (e.g., the current access load state of the storage device), wherein the value of X is greater under a high access load state, so as to avoid frequent switching of processing modes.

Through the steps described above, the processor 211 is able to advance the completion time of small data read commands without affecting the total execution time of all commands, so as to improve the response speed of small data read commands, thereby improving the user experience when the system is in a strong interactive state.

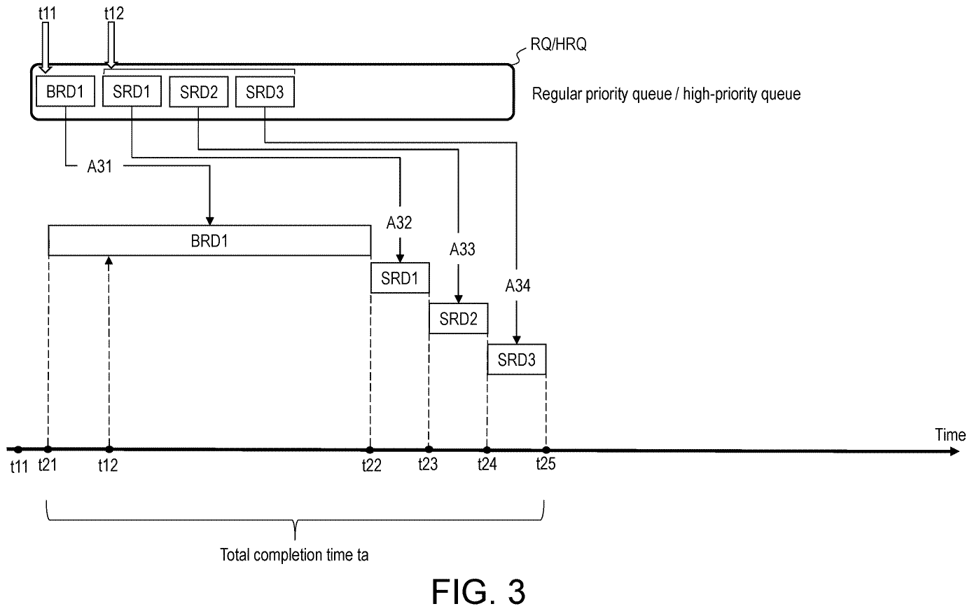

FIG. 3 is a schematic diagram illustrating the execution timing of read commands under a conventional scheduling method according to an embodiment of the present disclosure.

Referring to FIG. 3, FIG. 3 depicts the time sequence under the conventional read command execution mode. The upper portion of the figure illustrates the big data read command BRD1 and the multiple small data read commands SRD1, SRD2, SRD3 received at time points t11 and t12, respectively. These commands are assigned to the regular priority queue (RQ) or the high-priority queue (HRQ) based on their priority, and commands of the same priority are arranged in receipt order within the queue. Here, it is assumed that the big data read command BRD1 and the multiple small data read commands SRD1, SRD2, SRD3 all have the same priority.

The middle portion of the figure illustrates the actual execution process and time relationship of the commands. As shown by arrow A31, after the big data read command BRD1 is received at time point t11, it begins execution at time point t21. Since big data read commands typically have a large data amount, their execution time is relatively long. During the execution of the big data read command BRD1 (before the big data read command BRD1 has been completed), the system receives multiple small data read commands SRD1, SRD2, and SRD3 at time point t12.

In the conventional sequential execution mode, these small data read commands having the same command priority must wait for the big data read command BRD1 to complete before being executed sequentially (executed according to the receipt time in First In First Out (FIFO) order). As shown by arrow A32, the small data read command SRD1 is executed during the period from time point t22 to t23; as shown by arrow A33, the small data read command SRD2 is executed during the period from time point t23 to t24; as shown by arrow A34, the small data read command SRD3 is executed during the period from time point t24 to t25. The total completion time for all commands is ta, from time point t21 to t25. The notation “total completion time ta” below the time axis indicates the total duration from when the first command begins execution to when the last command completes.

FIG. 3 illustrates the problem in the conventional execution mode where small data read commands must wait for a big data read command to complete. Although the execution time of the small data read commands is relatively short (as shown in the figure, the execution intervals of SRD1, SRD2, and SRD3 are significantly shorter than that of BRD1), since they must wait in the queue for the big data read command BRD1 to complete, the response time is significantly prolonged. Accordingly, for a plurality of small data read requests related to user interaction, this delay directly affects the user experience.

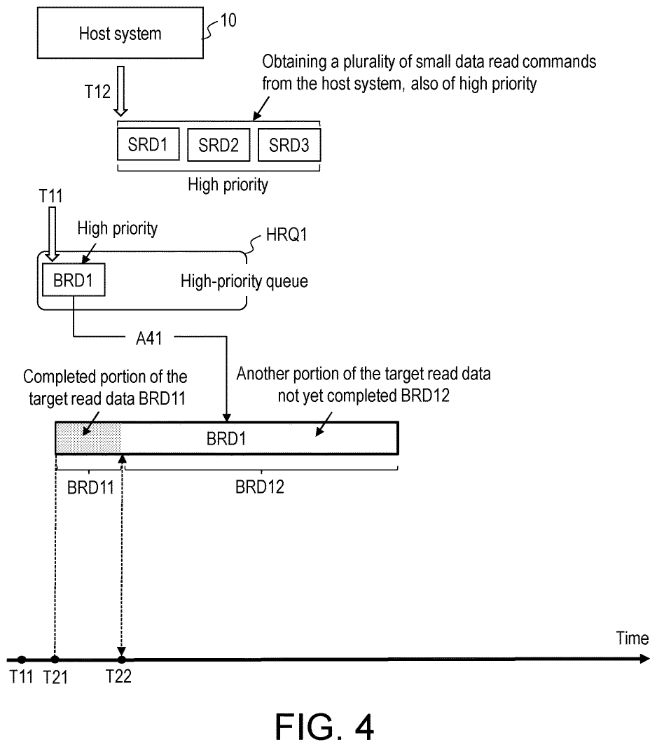

In contrast, the small data priority mode provided by the present disclosure allows the processor 211, upon detecting that the proportion of small data read commands reaches a preset threshold, to suspend the big data read command currently being executed and process the small data read commands with priority. This mechanism can effectively reduce the response time of small data read commands and improve the user interaction experience, while ensuring that the big data read command can ultimately complete execution through the yield data amount mechanism. The relevant details will be described using FIG. 4 through FIG. 7 below.

FIG. 4 is a timing diagram illustrating the storage device receiving a plurality of small data read commands during execution of a big data read command according to an embodiment of the present disclosure.

Referring to FIG. 4, the upper portion of the figure illustrates the read commands sent by the host system 10 to the storage device 20 at different time points, the middle portion illustrates how the commands are managed in the queues, and the lower portion illustrates the actual command execution timing.

As shown in the figure, the host system 10 sends, at time point T11 as indicated by an arrow, a big data read command BRD1 having high priority to the storage device 20, and the command is placed in a high-priority queue (HRQ) HRQ1 to await execution.

As shown by arrow A41, the storage device begins to execute the big data read command BRD1. On the time axis in the figure, the big data read command BRD1 begins execution at time point T21. Subsequently, at time point T12, the host system 10 further sends a plurality of small data read commands SRD1, SRD2, and SRD3 having the same high priority.

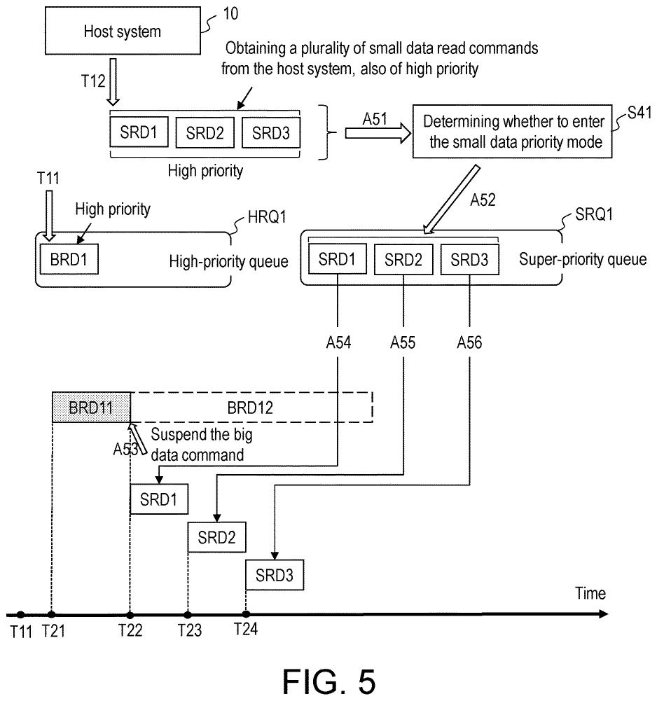

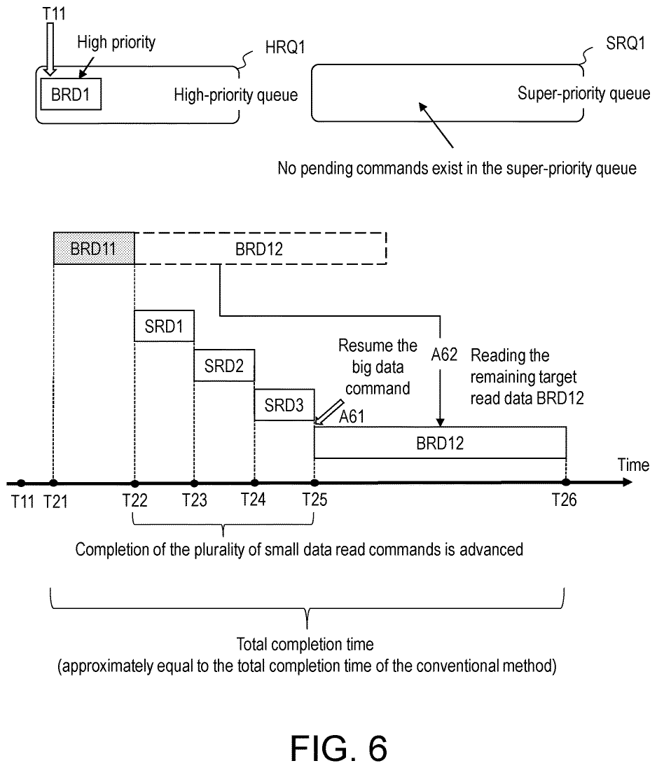

It should be noted that in another embodiment, the big data read command BRD1 may be obtained simultaneously with the small data read commands SRD1, SRD2, and SRD3. However, the present disclosure focuses on how to improve the delayed processing/response problem of the small data read commands SRD1, SRD2, and SRD3 caused during the period in which the system is executing the big data read command BRD1. That is, in this other embodiment, although the big data read command BRD1 and the small data read commands SRD1, SRD2, and SRD3 are obtained simultaneously, if execution of the big data read command BRD1 begins, the processing flow may also proceed to A41 in FIG. 4 and the subsequent processing flows of FIG. 5 and FIG. 6. That is, in yet another embodiment, if one or more of the small data read commands SRD1, SRD2, and SRD3 are executed first, the determination of whether to enter the small data priority mode will not be triggered, because the small data read commands that are executed first do not cause a response delay problem.

Referring back to FIG. 4, since the big data read command BRD1 involves a large data amount, at time point T22 after T21 (representing the period during which the big data read command BRD1 is being executed), the execution process may be divided into two parts: BRD11 and BRD12. BRD11 represents the target read data of the portion that has already been completed, and BRD12 represents the target read data of another portion that has not yet been completed.

Before determining how to assign the plurality of small data read commands to the appropriate queues, the processor 211 first determines whether to enter the small data priority mode. The following description uses FIG. 5 for illustration.

FIG. 5 is a scheduling diagram illustrating the storage device after entering the small data priority mode according to an embodiment of the present disclosure.

Continuing from the example of FIG. 4, referring to FIG. 5, in an embodiment, as shown by arrow A51, after the processor 211 receives the small data read commands, the processor 211 executes step S51 to determine whether the conditions for entering the small data priority mode are satisfied. Specifically, the processor 211 determines whether to enter the small data priority mode by analyzing the receipt order and quantity of the small data read commands, for example, by detecting whether at least N small data read commands exist among the most recently obtained M read commands. When the processor 211 determines that the current system is in a highly interactive real-time scenario, the processor 211 enters the small data priority mode.

After entering the small data priority mode, as shown by arrow A52, the processor 211 places the small data read commands SRD1, SRD2, and SRD3 into a super-priority queue (SRQ) SRQ1, where the processing priority of the super-priority queue (SRQ) SRQ1 is higher than that of the high-priority queue (HRQ) HRQ1 and the regular priority queue (RQ). This queue management mechanism ensures that the small data read commands are processed with priority.

Meanwhile, the figure shows that the processor 211 has executed a portion of the big data read command BRD1, namely the BRD11 portion in the figure. When it is necessary to begin executing the small data read commands in the super-priority queue (SRQ) SRQ1, as shown by arrow A53, at time point T22, the processor 211 suspends execution of the big data read command BRD1 and precisely saves the current execution state, including the boundary information between the completed portion BRD11 and the uncompleted portion BRD12.

In an embodiment, when the processor 211 suspends execution of the big data read command BRD1, the processor 211 needs to precisely save the current execution state to ensure that execution can be accurately resumed subsequently. The implementation details are described in detail below.

When the processor 211 determines that the big data read command BRD1 currently being executed needs to be suspended, the processor 211 first determines the current execution position of the big data read command BRD1, that is, the precise boundary point between the completed portion BRD11 and the uncompleted portion BRD12. Specifically, the processor 211 records a plurality of key state parameters, including but not limited to: the number of bytes currently read, the physical address of the memory for the current read operation, logical address mapping information, data buffer state, and related register values.

The processor 211 saves the state information to a dedicated context save area, which may be located within a specific reserved space of the buffer memory 214. To ensure the integrity and consistency of the state information, the processor 211 performs atomic operations to temporarily block any operations that may interfere with or modify these state parameters during the state save process. In addition, the processor 211 generates a unique context identifier used to associate the suspended big data read command with its saved state information.

For a big data read command that has been partially executed, the processor 211 precisely calculates the data amount of the completed portion BRD11 and saves this information as an important indicator of the current execution progress. At the same time, the processor 211 also records all necessary information related to the uncompleted portion BRD12, including the remaining data amount to be read, the target storage area, and related data processing parameters.

After the state save is completed, the processor 211 releases some hardware resources currently associated with the big data read command BRD1, such as data transfer channels and memory access permissions, so as to allow these resources to be used by the small data read commands to be executed subsequently. However, the processor 211 retains the allocation markers of certain critical resources associated with the big data read command BRD1 to prevent these resources from being erroneously reallocated by the system to other long-running tasks.

Regarding the state associated with cache management, the processor 211 records the positions and validity flags of data blocks in the static read buffer that are associated with the big data read command BRD1. If partially read data is already in the cache but has not yet been transferred to the destination, the processor 211 marks these data blocks as a “suspended pending processing” state, ensuring that they are not evicted by the cache replacement algorithm before execution is resumed.

When execution of the big data read command needs to be resumed, the processor 211 retrieves the complete state information through the previously saved context identifier and restores the execution environment in the reverse process, including resetting the relevant register values, restoring data transfer channel configurations, and reobtaining the necessary hardware resources. The processor 211 takes particular care to ensure that the resumption point precisely corresponds to the execution position at the time of suspension, so as to achieve seamless execution resumption, as if the big data read command had never been interrupted.

The context save and restore mechanism ensures that after being suspended, the big data read command is able to accurately continue execution from the suspension point without restarting the entire read process, thereby avoiding resource waste and ensuring the integrity and consistency of data operations.

After suspending the big data read command BRD1, the processor 211 sequentially executes the small data read commands in the super-priority queue (SRQ) SRQ1 in First In First Out (FIFO) order. As shown by arrow A54, the processor 211 first executes SRD1, completing it during the time period from T22 to T23; as shown by arrow A55, the processor 211 then executes SRD2, completing it during the time period from T23 to T24; as shown by arrow A56, the processor 211 finally executes SRD3, completing it during the time period from T24 to T25. The processor 211 also ensures that the small data read commands have sufficient cache resources during execution (corresponding substantially to the dynamic read buffer) by dividing the buffer memory 214 into a static read buffer and a dynamic read buffer.

In FIG. 5, the dashed-line box represents the uncompleted target read data BRD12 of the suspended big data read command BRD1. After executing each small data read command, the processor 211 updates the yield data amount value of the big data read command according to the yield data amount mechanism. When all small data read commands have been executed, or when the yield data amount drops to zero or a negative value (non-positive value), the processor 211 resumes execution of the big data read command BRD1 and continues processing the uncompleted target read data BRD12.

FIG. 6 is a timing diagram illustrating the storage device resuming execution of the big data read command after completing the small data read commands, according to an embodiment of the present disclosure.

Continuing from the example of FIG. 5, referring to FIG. 6, after all small data read commands have been executed, as shown by arrow A61, the processor 211 begins resuming execution of the previously suspended big data read command at time point T25. The resumption process is based on the previously saved context state information, ensuring that the big data read command is able to accurately continue execution from the suspension point. As shown by arrow A62, the processor 211 reads the remaining target read data BRD12, starting from time point T25 and completing at time point T26.

It should be noted that the time axis shows that the small data read commands SRD1, SRD2, and SRD3 are able to be processed and completed (e.g., at corresponding completion time points T23, T24, T25) before the big data read command BRD1 is fully executed (e.g., at T26). The optimization of this execution order directly improves the response speed of the small data read commands. In particular, for small data read requests associated with user interaction, the improvement in response speed significantly improves the user experience.

In addition, the total completion time TA annotated at the bottom of FIG. 6, which approximates the total completion time ta of the conventional method, indicates that although the small data priority mode of the present disclosure adjusts the instruction execution order, the overall execution time is not significantly increased. This characteristic is critical for practical applications, as it means that the present disclosure is able to enhance the user interaction experience without degrading overall system efficiency.

Comparing FIG. 6 with FIG. 3, it is clearly seen that under the conventional execution method, the small data read commands must wait for the big data read command to be fully executed before they can begin execution, resulting in response delay, and the user's perception of response speed depends precisely on the delay of critical interactive commands. In the small data priority mode of the present disclosure, the small data read commands are able to complete execution earlier, greatly improving the response speed to user interaction requests, while ensuring that the big data read command is ultimately able to complete execution.

The multiple embodiments of FIG. 4 through FIG. 6 illustrate the core technical process of the present disclosure: the processor 211 implements preemptive scheduling of small data read commands over big data read commands under equal command priority through a precise suspend and resume mechanism. The processor 211 suspends the big data read command BRD1 and saves its execution context state, and then executes the small data read commands in the super-priority queue (SRQ) SRQ1. The super-priority queue (SRQ) SRQ1 is a key innovation of the present disclosure, ensuring that small data read commands are able to be executed with priority even when they have the same command priority as other commands. After the small data read commands have been executed, the processor 211 accurately resumes execution of the big data read command based on the saved context state. This mechanism completes the small data read commands ahead of schedule without significantly increasing the total completion time, optimizing the system's responsiveness to user interaction requests.

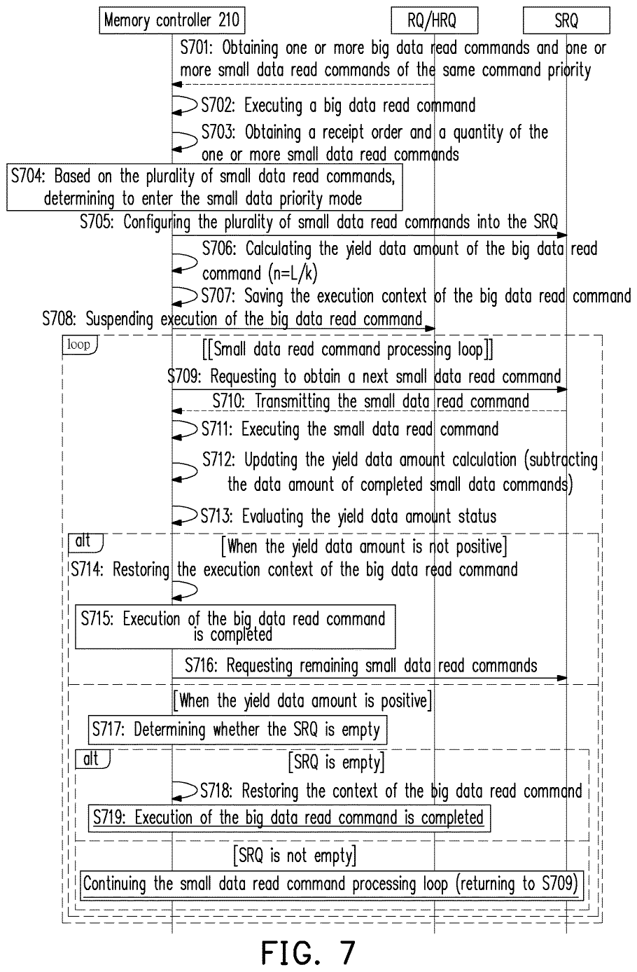

FIG. 7 is a detailed interaction timing diagram illustrating the interactions among the memory controller, the regular priority queue (RQ)/high-priority queue (HRQ), and the super-priority queue (SRQ) according to an embodiment of the present disclosure.

Referring to FIG. 7, FIG. 7 presents, in the form of a timing diagram, the detailed interaction process between the memory controller 210 and queues of different priorities (RQ/HRQ and SRQ). The entire process may be divided into an initial phase, a phase of entering the small data priority mode, and a small data processing loop phase.

In the initial phase, the process begins at step S701, where the memory controller 210 obtains one or more big data read commands and one or more small data read commands having the same command priority from the regular priority queue or the high-priority queue (RQ/HRQ). Upon receiving these commands, the memory controller 210 begins executing the big data read command at step S702. In addition, the memory controller 210 obtains the receipt order and quantity of the one or more small data read commands at step S703, so as to perform the subsequent determination of whether to enter the small data priority mode.

At step S704, the memory controller 210 determines whether to enter the small data priority mode based on the receipt order and quantity of the small data read commands having the same command priority received in the regular priority queue or the high-priority queue. This determination may employ a sliding window counting mechanism to detect whether at least N small data read commands exist among the most recently obtained M read commands. If the condition is satisfied, the memory controller 210 determines that the current system is in a highly interactive real-time scenario and needs to enter the small data priority mode.

After entering the small data priority mode, the memory controller 210 configures a plurality of small data read commands into the super-priority queue (SRQ) at step S705. At step S706, the memory controller 210 calculates the yield data amount of the big data read command using the formula n=L/k, wherein L is the total data length of the big data read command and k is an adjustable parameter. The yield data amount is used to control the degree to which the big data read command is preempted, so as to prevent the big data read command from being indefinitely delayed.

To prepare for suspending the big data read command currently being executed, the memory controller 210 saves the execution context of the command at step S707, which may include key parameters such as the boundary information between the completed and uncompleted portions, the current read address, and the cache state. Subsequently at step S708, the memory controller 210 sends a suspend signal to the high-priority queue (HRQ) to formally suspend execution of the big data read command.

The process then enters the small data read command processing loop phase. At step S709, the memory controller 210 requests the next small data read command from the super-priority queue (SRQ). The super-priority queue (SRQ) transmits the small data read command to the memory controller 210 at step S710. The memory controller 210 executes the small data read command at step S711 to complete the corresponding data read task.

After completing each small data read command, the memory controller 210 updates the yield data amount at step S712 by subtracting the data amount of the completed small data read command. At step S713, the memory controller 210 evaluates the state of the updated yield data amount (determining whether the updated yield data amount is a positive value) to determine whether to continue executing small data read commands or to resume execution of the big data read command.

The branches of the timing diagram illustrate two possible cases (whether the yield data amount is a positive value): when the yield data amount is not a positive value (indicating that the yield data amount has been fully consumed and the big data read command must begin resuming execution), the memory controller 210 restores the execution context of the big data read command at step S714 and completes execution of the big data read command at step S715. Subsequently at step S716, the memory controller 210 requests the super-priority queue (SRQ) to process the remaining small data read commands.

In the present embodiment, the memory controller 210 employs a special processing mechanism to ensure that all read commands are ultimately processed regardless of the state of the yield data amount. Specifically, after the memory controller 210 completes execution of the big data read command at step S715, the memory controller 210 proceeds to step S716 to actively obtain and process one or more remaining small data read commands that have not yet been executed in the small data priority mode. This processing approach ensures that even when the yield data amount has been exhausted, the small data read commands in the super-priority queue (SRQ) are not forgotten or subject to prolonged processing delays.

In addition, after completing the current big data read command, if a next big data read command pending processing exists in the system, the memory controller 210 recalculates a new yield data amount corresponding to the next big data read command based on the characteristics of the next big data read command. Specifically, the memory controller 210 obtains the total data length of the next big data read command and applies the formula n=L/k to calculate the initial value of the new yield data amount. If the next big data read command is suspended, as subsequent small data read commands continue to be executed, the memory controller 210 updates the new yield data amount value based on the actual data amount of each small data read command executed under the small data priority mode. This dynamic update mechanism ensures that the system can continuously adapt to the current workload and maintain a reasonable balance between small data read commands and big data read commands.

On the other hand, when the yield data amount is a positive value, the memory controller 210 determines at step S717 whether the super-priority queue (SRQ) is empty. If the super-priority queue (SRQ) is empty, indicating that all small data read commands have been executed, the memory controller 210 restores the context of the big data read command at step S718 and completes execution of the big data read command at step S719. If the super-priority queue (SRQ) is not empty, indicating that small data read commands still require processing, the memory controller 210 continues the small data read command processing loop at step S720 and returns to step S709.

FIG. 7 clearly illustrates the core technical process of the present disclosure: by establishing a dedicated super-priority queue (SRQ), implementing a precise execution state saving and restoring mechanism, and employing a data-amount-based yield mechanism, the memory controller 210 advances the completion time of small data read commands that may involve a strong interactive state without affecting the overall final completion time of multiple commands, thereby improving the response speed of small data read commands.

This implementation is particularly suitable for mobile device scenarios with high real-time response requirements, and is capable of improving the user experience in highly interactive scenarios without significantly impacting the overall execution efficiency of large data block tasks.

The present embodiment further provides a computer program product comprising computer-readable code, or a non-volatile computer-readable storage medium carrying computer-readable code, wherein when the computer-readable code runs in a processor, the processor executes the steps of the memory management method described above. The computer program product may be implemented through hardware, firmware, software, or a combination thereof. In an optional embodiment, the computer program product is embodied as a computer storage medium, and in another optional embodiment, the computer program product is embodied as a software product, such as a Software Development Kit (SDK), or the like.

Based on the foregoing, the memory management method and memory controller provided by the present disclosure can achieve preemptive scheduling of small data read commands over big data read commands at the same command priority. By determining the receipt frequency and quantity of small data read commands, the present disclosure dynamically determines whether to enter the small data priority mode, enabling the system to intelligently adapt to different workload environments. In the small data priority mode, the method suspends the big data read command currently being executed, executes the small data read commands with priority, and based on the configured yield data amount mechanism, ensures that the big data read command can eventually complete execution, thereby avoiding resource starvation.

Furthermore, the present disclosure dynamically allocates memory cache resources to ensure that sufficient cache space is always available for small data read commands, further improving the execution efficiency of small data read commands. At the same time, the present disclosure also provides a flexible mode exit mechanism, such that when the subsequently obtained small data read commands decrease, the system can promptly restore the normal scheduling mode, maintaining efficient utilization of system resources.

The present disclosure is particularly applicable to mobile device scenarios with high real-time response requirements, improving user experience in strong interactive scenarios such as message notifications, photo previews, and AR interactions by optimizing the read response speed of small data blocks, without significantly affecting the overall execution efficiency of big data block tasks.

Finally, it should be noted that the above embodiments are only intended to illustrate the technical solutions of the present disclosure and are not intended to limit the same. Although the present disclosure has been described in detail with reference to the foregoing embodiments, those skilled in the art should understand that modifications may still be made to the technical solutions described in the foregoing embodiments, or some or all of the technical features thereof may be equivalently replaced. Such modifications or replacements do not cause the essence of the corresponding technical solutions to deviate from the scope of the technical solutions of the embodiments of the present disclosure.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A memory management method, applied to a storage device configured with a memory module, the method comprising:
obtaining one or more big data read commands and one or more small data read commands having the same command priority;
determining whether to enter a small data priority mode based on the receipt order and quantity of the one or more small data read commands; and
after entering the small data priority mode, if a big data read command is currently being executed, suspending execution of the big data read command and beginning to execute the one or more small data read commands.

2. The memory management method as claimed in claim 1, wherein during a period in which the big data read command is suspended, the method further comprising:
obtaining a yield data amount based on a total data amount corresponding to the big data read command;
each time a small data read command is completed, subtracting a data amount corresponding to the small data read command from the yield data amount to update the yield data amount; and
when the updated yield data amount is not a positive value, resuming and executing the big data read command.

3. The memory management method as claimed in claim 2, wherein the yield data amount is calculated according to the following formula:
$$n = L / k$$
wherein n is the yield data amount, L is the total data length corresponding to the big data read command, and k is an adjustable parameter,
wherein the total data length corresponding to the big data read command is greater than a data threshold, and the data amount corresponding to each small data read command is not greater than the data threshold.

4. The memory management method as claimed in claim 3, further comprising:
adjusting a value of k correspondingly based on a current access load state of the storage device;
wherein the higher the access load state, the greater the value of k.

5. The memory management method as claimed in claim 3, further comprising:
after completing execution of the big data read command, continuing to execute one or more remaining small data read commands that have not yet been executed in the small data priority mode; and
if the yield data amount is a positive value and all of the one or more small data read commands have been completed, resuming and executing the big data read command.

6. The memory management method as claimed in claim 5, further comprising:
after completing execution of the big data read command, recalculating a new yield data amount corresponding to a next big data read command based on the next big data read command; and
if the next big data read command is suspended, updating the new yield data amount based on a data amount of each small data read command executed under the small data priority mode.

7. The memory management method as claimed in claim 1, wherein determining whether to enter the small data priority mode based on the receipt order and the quantity of the one or more small data read commands comprises:
detecting whether at least N small data read commands exist among the most recently obtained M read commands, wherein M is greater than N, and both are positive integers; and
if at least N small data read commands are detected, entering the small data priority mode.

8. The memory management method as claimed in claim 7, wherein during a period of being in the small data priority mode, the method further comprising:
detecting whether any small data read command exists among the most recently consecutively obtained X read commands;
if no small data read command exists among the most recently consecutively obtained X read commands, exiting the small data priority mode;
wherein X is a positive integer, and the value of X is dynamically adjusted based on the current access load state of the storage device, wherein the higher the access load state, the greater the value of X.

9. The memory management method as claimed in claim 1, wherein after entering the small data priority mode, suspending execution of the big data read command if the big data read command is currently being executed and beginning to execute the one or more small data read commands comprises:
establishing a super-priority queue (SRQ) for recording the one or more small data read commands, wherein the big data read command is recorded in a high-priority queue (HRQ) or a regular priority queue (RQ), and the super-priority queue (SRQ) is processed with higher priority than the high-priority queue (HRQ) or the regular priority queue (RQ);
suspending the big data read command currently being executed and saving a context state of an execution process of the big data read command;
processing the one or more small data read commands in the super-priority queue (SRQ) in First In First Out (FIFO) order; and
when resuming execution of the big data read command, continuing to execute the big data read command based on the context state.

10. The memory management method as claimed in claim 9, further comprising:
dividing cache resources of the memory module into a static read buffer and a dynamic read buffer;
dedicating the dynamic read buffer to storing data corresponding to the super-priority queue (SRQ);
allocating the static read buffer to data corresponding to the high-priority queue (HRQ) or the regular priority queue (RQ); and
in the small data priority mode, when a storage space of the dynamic read buffer is insufficient, allowing small data read commands in the super-priority queue (SRQ) to request storage space from the static read buffer, and prohibiting the storage space of the dynamic read buffer from being allocated to commands other than those in the super-priority queue (SRQ).

11. A memory controller for controlling a storage device configured with a memory module, the memory controller comprising:
a memory interface control circuit configured to be electrically connected to the memory module; and
a processor electrically connected to the memory interface control circuit, wherein the processor is further electrically connected to a connection interface circuit of the storage device to be electrically connected to a host system,
wherein the processor is configured to:
obtain one or more big data read commands and one or more small data read commands having the same command priority;
determine whether to enter a small data priority mode based on the receipt order and quantity of the one or more small data read commands; and
after entering the small data priority mode, if a big data read command is currently being executed, suspend execution of the big data read command and begin to execute the one or more small data read commands.

12. The memory controller as claimed in claim 11, wherein the processor is further configured to:
during a period in which the big data read command is suspended, obtain a yield data amount based on a total data amount corresponding to the big data read command;
each time a small data read command is completed, subtract a data amount corresponding to the small data read command from the yield data amount to update the yield data amount; and
when the updated yield data amount is not a positive value, resume and execute the big data read command.

13. The memory controller as claimed in claim 12, wherein the processor is configured to calculate the yield data amount according to the following formula:
$$n = L / k$$
wherein n is the yield data amount, L is the total data length corresponding to the big data read command, and k is an adjustable parameter,
wherein the total data length corresponding to the big data read command is greater than a data threshold, and the data amount corresponding to each small data read command is not greater than the data threshold.

14. The memory controller as claimed in claim 13, wherein the processor is further configured to:
adjust a value of k correspondingly based on a current access load state of the storage device;
wherein the higher the access load state, the greater the value of k.

15. The memory controller as claimed in claim 13, wherein the processor is further configured to:
after completing execution of the big data read command, continue to execute one or more remaining small data read commands that have not yet been executed in the small data priority mode; and
if the yield data amount is a positive value and all of the one or more small data read commands have been completed, resume and execute the big data read command.

16. The memory controller as claimed in claim 15, wherein the processor is further configured to:
after completing execution of the big data read command, recalculate a new yield data amount corresponding to a next big data read command based on the next big data read command; and
if the next big data read command is suspended, update the new yield data amount based on a data amount of each small data read command executed under the small data priority mode.

17. The memory controller as claimed in claim 11, wherein the processor is configured to determine whether to enter the small data priority mode by:
detecting whether at least N small data read commands exist among the most recently obtained M read commands, wherein M is greater than N, and both are positive integers; and
if at least N small data read commands are detected, entering the small data priority mode.

18. The memory controller as claimed in claim 17, wherein the processor is further configured to:
during a period of being in the small data priority mode, detect whether any small data read command exists among the most recently consecutively obtained X read commands;
if no small data read command exists among the most recently consecutively obtained X read commands, exit the small data priority mode;
wherein X is a positive integer, and the value of X is dynamically adjusted based on the current access load state of the storage device, wherein the higher the access load state, the greater the value of X.

19. The memory controller as claimed in claim 11, wherein after entering the small data priority mode, the processor is configured to:
establish a super-priority queue (SRQ) for recording the one or more small data read commands, wherein the big data read command is recorded in a high-priority queue (HRQ) or a regular priority queue (RQ), and the super-priority queue (SRQ) is processed with higher priority than the high-priority queue (HRQ) or the regular priority queue (RQ);
suspend the big data read command currently being executed and save a context state of an execution process of the big data read command;
process the one or more small data read commands in the super-priority queue (SRQ) in First In First Out (FIFO) order; and
when resuming execution of the big data read command, continue to execute the big data read command based on the context state.

20. The memory controller as claimed in claim 19, wherein the processor is further configured to:
divide cache resources of the memory module into a static read buffer and a dynamic read buffer;
dedicate the dynamic read buffer to storing data corresponding to the super-priority queue (SRQ);
allocate the static read buffer to data corresponding to the high-priority queue (HRQ) or the regular priority queue (RQ); and
in the small data priority mode, when a storage space of the dynamic read buffer is insufficient, allow small data read commands in the super-priority queue (SRQ) to request storage space from the static read buffer, and prohibit the storage space of the dynamic read buffer from being allocated to commands other than those in the super-priority queue (SRQ).
